(19) United States
(12) Patent Application Publication
(10) Pub. No.: US 2023/0209418 A1
(43) Pub. Date: Jun. 29, 2023

(54) METHOD OF LOCATING Wi-Fi DEVICES

(71) Applicants: THE REGENTS OF THE UNIVERSITY OF CALIFORNIA, Oakland, CA (US); King Abdulaziz City for Science and Technology (KACST), Riyadh (SA)

(72) Inventors: Ramesh R. RAO, La Jolla, CA (US); Hans Chinghan YU, San Diego, CA (US); Khaled ALHAZMI, Riyadh (SA)

(21) Appl. No.: 17/922,747

(22) PCT Filed: Apr. 30, 2021
(86) PCT No.: PCT/US2021/030334

§ 371 Date: Nov. 1, 2022

Related U.S. Application Data
(60) Provisional application No. 63/019,067, filed on May 1, 2020.

(51) Int. Cl. H04W 36/00; H04W 36/30; H04W 36/08; H04W 64/00

(52) U.S. Cl. CPC H04W 36/00837; H04W 36/30; H04W 36/08; H04W 64/00; H04W 36/00835; H04W 84/12

(57) ABSTRACT

A method for managing wireless connections in a network with a computer controller and plurality of access points (APs) uses an industry-standard protocol to determine client roaming and location. When a smartphone connects to one of the APs, neighboring APs can be quickly identified. The controller triggers the smartphone to probe neighboring APs and collects signal strength information and generates a map. The controller estimates the relative location of the smartphone among the APs and decides whether to steer the smartphone to a different AP based on signal strength and/or other variables.

### RELATED APPLICATIONS

This application claims the benefit of the priority of U.S. Provisional Application No. 63/019,067, filed May 1, 2020, which is incorporated herein by reference in its entirety.

### FIELD OF THE INVENTION

The present invention relates to a method and system for detecting radio spectrum parameters and wireless resources for improved localization, roaming and handoffs.

### BACKGROUND

The applications market Wi-Fi has been continuously growing. Recent reports showed the market worth could reach $16.8 billion by 2023 and technology supporting Wi-Fi applications are estimated to have a compound average growth rate of 30%. Many applications require knowledge of the location of access points (“APs”), client stations, or both. Location-based computing can be done in portable devices to help improve performance and provide better quality of service (QoS). For example, when a user brings a smartphone close to a wireless printer, the infrastructure can inform both smartphone and printer to be ready for a print. Moreover, when a smart phone moves away from its currently associated AP, the infrastructure quickly reacts against the change and helps the phone locate a new AP for a hand off, preventing ongoing traffic from being dropped. Today, many devices are equipped with Wi-Fi functionality, so it would be very cost efficient if topology information could be retrieved directly through existing Wi-Fi infrastructure instead of relying on extra hardware such as radar, lidar, or GPS. Topology information, such as locations, BSSIDs, operating channels, or traffic load on neighboring APs, is valuable to clients but more easily accessible from the infrastructure side because an infrastructure is generally managed by a single entity, and its devices could share a unified interface. If infrastructure is able to share such information to clients, clients can use it to select APs for roaming in a timely manner. Lack of channel information has moderate impact in 2.4 GHz band because most APs are operated on three non-overlapping channels, and devices can scan those channels for new APs first. However, the limited bandwidth within the 2.4 GHz band can no longer sustain the continuing growth of applications and has driven people to use the 5 GHz band, which has a larger bandwidth and more desirable characteristics.

One of the benefits of the 5 GHz band is that its channels generally do not overlap. There are 32 non-overlapping channels in the 5 GHz band and most channels are free from inter-channel interference, making the 5 GHz band more suitable for dense deployment and also more challenging in channel selection. A significant shortcoming of 5 GHz wavelengths is that they provide reduced range due to signal attenuation by atmospheric water, water-containing objects (such as trees), and other physical structures. To address this issue, more APs are installed closer together to eliminate blind spots, leading to the requirement of switching connections more frequently.

The Wi-Fi roaming process is usually initialized by clients that have no prior knowledge of network topology, yet they are tasked with quickly finding correct APs before they are disconnected. Many clients collect necessary information with time-consuming full-channel scans, during which no ongoing communications can occur.

FIG. 1 illustrates a standard Wi-Fi hand-off process. A client first does a full-channel scan, evaluates the results, and then tries to connect to a selected AP. There are two challenges in this process. First, a full-channel scan takes relatively long time, so many clients only start scanning after they detect packet loss or their current links have become unstable. For many streaming applications, this would be too late because a full-channel scan can take up to 500 ms, long enough to interrupt a video streaming or a VoIP call. An alternative strategy is for the clients to focus on scanning a small set of channels at a time. These shorter scans would slightly break traffic and have a smaller impact on streaming services. Second, after a client gains full-channel knowledge, and there are multiple APs with similar signal strength, it needs to decide which AP to connect to. If it connects to an AP that it is moving away from, another hand off might happen quickly. Location information could provide another degree of certainty to selection metrics.

The bottom line of the cost paid for full-channel knowledge is the time and energy for a full-channel scan.

Localization is the heart of location-based services. Tseng et al. assumed the location of clients is known and showed that location information could play an important role in helping clients find correct APs. Following the assumption that location information was available, Tseng et al. proposed using a location server to keep track of clients and suggest probable next APs. One method for localization is triangulation, which requires obtaining channel information from at least three APs. That, however, could be challenging because Wi-Fi APs generally operate on different channels. SyncScan overcame this challenge by synchronizing beacon timers so that the arrival times of beacons in neighboring channels differ by a fixed amount of time. For example, assume the beacon interval is T, beacons in channel 1 arrive at t, those in channel 2 arrive at t+d, and those in channel n arrive at t+(n−1)d. If (n−1)d is smaller than T, then a client can quickly scan all the channels in T. With this solution, however, firmware-level support is required to make timers work coherently across APs.

Another solution seen in the literature is to use multiple radios [8] in which some radios are used for background scanning for potential hand off candidates, while others are used for data transmission. In an ideal situation, as the node gets closer to a new AP, the scanning interface associates with that new AP because of a stronger RSSI and starts data transmission, providing a seamless hand off. The data sending interface disconnects from the old AP and starts scanning. This solution adds another layer of complexity and needs an organized way to maintain routing and ARP tables. A few works have proposed the use of Multi-path TCP (MPTCP) to address this issue. However, MPTCP has not yet been integrated into Linux's mainline kernel and is not widely seen on Android devices.

In addition to estimating object location based on its RSS or angular properties, the location of a device can also be identified when it comes closer and connects to a known AP. This approach does not require measuring RSS, nor does it require special antenna configurations for extracting temporal or spatial properties of radios. As long as the device stays connected with the AP, it follows that it must be somewhere close to that AP. Depending on the coverage of each AP, the estimation error could vary from tens of meters in an indoor environment to hundreds of meters outdoors.

Selective scans provide another approach that can help reduce scanning time by intentionally skipping busy channels or channels without available AP. Jin and Choi considered two cases where a scanning client can skip scanning a particular channel: if the client knows in advance that 1) no AP matches the requirements or 2) no AP is in that channel. The authors enabled 802.11k support in their APs, so that the clients could learn the operating channels of neighboring APs. The client can easily use the knowledge learned from beacons and initiate a hand-off. The inventive approach follows a similar thought process but implements it in a different way.

### SUMMARY

The inventive system and method assist a client Wi-Fi device to find a good access point (AP) in a wireless network to which it can connect. This approach replaces the conventional time-consuming full-channel scan with a selective channel scan. Through the selective channel scan, the infrastructure can construct a signal strength map and estimate the location of the device. Finally, the infrastructure uses the collected location information to suggest to the client device an AP for providing a better connection. A particular advantage of the inventive scheme is that it requires no hardware or software modification on the client device, which could void the warranty or raise privacy concerns. The inventive method can be used to enhance communication systems operations for Wi-Fi, wireless, internet of things (IoT), localization, and roaming.

According to embodiments of the inventive scheme, Roaming as a Service (RaaS)/Wi-Fi roaming is used as a location-based service, a combined solution for roaming and location estimation in which a controller learns the location of clients by asking them to selectively scan access points (APs) and helps clients roam with the standard 802.11v protocol. No hardware or software modification at the client side is necessary, and we will show that the proposed solution is practical and can be implemented purely on a commercial AP platform.

Using the inventive approach, full-channel knowledge is turned into a coarse location using the received signal strength indices (RSSI). A more precise location can then be found using angle-of-arrival and time-of-fly. The total amount of time a client needs to complete a scan can be determined from the simple relationship: total scanning time=number of channels×time spent per channel. If a client decides to do a passive scan, then the time spent in each channel is equal to the beacon interval, which is 100 ms in general; if a client is willing to do an active scan, then that value reduces to 30-40 ms.

In fact, roaming candidates generally only exist on some channels in a managed network. If a client possesses sufficient information to focus only on those channels, full-channel scans can be avoided, significantly reducing the amount of time spent on scanning from several hundred milliseconds to tens of milliseconds. In addition, selective scans also assist clients in meeting the 100 ms gap required by many streaming services. By scanning only 1-3 channels at once, the location of the client can be estimated with zero cost.

In one aspect of the invention, a network includes a computer controller and plurality of access points (APs) in which all of the APs are known. When a smartphone connects to one of the APs, the neighboring APs can be quickly identified. The controller asks the smartphone to probe neighboring APs with customized 802.11v commands. The controller then collects signal strength information and generates a map. The controller estimates the relative location of the smartphone among the APs and decides whether to steer the smartphone to a different AP based on signal strength and/or other variables.

This approach does not require customization at stations. Any off-the-shelf Wi-Fi devices that support the latest IEEE 802.11 Wi-Fi standard can work as a station node. All that is required of a station is that it send out standard-specified signals when requested. These signals can then be used to measure the environment. In situations where there may not be enough stations, some of the APs can be converted into stations.

In one aspect of the invention, a method for managing connection of a wireless client to a wireless network comprising a plurality of access points (APs) includes configuring a network controller to collect location information from the wireless client using a standardized hand-off protocol by: receiving at the wireless client a channel/AP list from a first associated AP; switching the wireless client to a different channel and actively probing one or more non-associated APs; measuring link parameters at the one or more non-associated APs by using the probe requests from the wireless client; switching the wireless client back to the first associated AP; retrieving link parameters from the one or more non-associated APs; and providing information to the wireless client for linking to a different AP based on the link parameters. The network controller may identify a preferred subset of APs based on the link parameters and generates a preferred candidate list (PCL) comprising non-associated APs so that the information provided to the wireless client includes the PCL. In some embodiments, the wireless network operates on an industry standard that comprises BSSID Transition Management (BTM) frames, and wherein the step of receiving at the wireless client comprises is initiated by transmitting from the first associated AP an unsolicited BTM frame to trigger a selective scan of the one or more non-associated APs. The industry standard is preferably IEEE 802.11v. The link parameters that are retrieved from at least three APs include signal strength, allowing a location of the wireless client to be estimated from a combination of the signal strengths retrieved at the at least three APs. The estimated location of the wireless client may be determined from an intersection of symmetrical areas having diameters corresponding to the signal strengths.

In another aspect of the invention, a method for managing connection of a wireless client to a wireless network having a controller and a plurality of access points (APs), where the wireless network operates on an industry standard protocol that includes BSSID Transition Management (BTM) frames, includes: transmitting from a first associated AP in communication with the wireless client an unsolicited BTM frame comprising a preferred list of non-associated APs, wherein the BTM frame triggers a selective scan by the wireless client of the preferred non-associated candidate APs; returning from the wireless client to the controller link parameters for each of the preferred non-associated candidate APs; and if the link parameters for one of the preferred non-associated APs indicate an improved connection relative to the first associated AP, switching the wireless client to the preferred non-associated AP. In some embodiments, the industry standard is IEEE 802.11v. The link parameters retrieved from at least three APs may include signal strength, allowing a location of the wireless client to be estimated from a combination of the signal strengths retrieved at the at least three APs. The estimated location of the wireless client may be an intersection of symmetrical areas having diameters corresponding to the signal strengths.

In still another aspect of the invention, a method for managing connection of a wireless client to a wireless network comprising a plurality of access points (APs) and a network controller includes: receiving at the wireless client a channel/AP list from a first associated AP of the plurality of APs; switching the wireless client to a different channel and causing the wireless client to actively probe one or more non-associated APs on the channel/AP list; measuring link parameters at the one or more non-associated APs by using the probe requests from the wireless client; switching the wireless client back to the first associated AP; retrieving link parameters from the one or more non-associated APs; and providing information to the wireless client for linking to a different AP based on the link parameters. The network controller may identify a preferred subset of APs based on the link parameters and generates a preferred candidate list (PCL) comprising non-associated APs and wherein the information provided to the wireless client includes the PCL. In some embodiments, the wireless network operates on an industry standard that comprises BSSID Transition Management (BTM) frames, and wherein the step of receiving at the wireless client is initiated by transmitting from the first associated AP an unsolicited BTM frame to trigger a selective scan of the one or more non-associated APs. In some embodiments, the industry standard is IEEE 802.11v. The link parameters may be retrieved from at least three APs and include signal strength, so that a location of the wireless client can be estimated from a combination of the signal strengths retrieved at the at least three APs. The estimated location of the wireless client may be an intersection of symmetrical areas having diameters corresponding to the signal strengths.

The inventive scheme provides a number of advantages over existing methods, including using a standard Wi-Fi management frame to trigger selective scans at the client side to avoid time-consuming full-channel scans and maintain the QoS of VoIP and streaming services. This approach does not require hardware or software modification at the client side and can be easily deployed on existing Wi-Fi networks. It is compatible with existing localization solutions and provides a path toward a more complete implementation of such solutions at minimal cost.

The inventive approach is also applicable to detecting radio spectrum parameters in addition to wireless channel resources in an organized manner. It consists of apparatuses that are able to communicate/send data over wireless links, measure environmental parameters based on incoming signals, process and react against control commands, and a method of collecting measured data for analysis.

While there are many wireless communication standards that meet the aforementioned requirements, the embodiments disclosed herein employ the IEEE 802.11 Wi-Fi standard. The access points and station nodes work together to collect environmental parameters.

### BRIEF DESCRIPTION OF THE DRAWINGS

FIG. 1 illustrates a standard Wi-Fi hand-off process (IEEE 802.11).

FIG. 2 is a diagram of a system architecture for an enterprise network with an additional overlay according to an embodiment of the invention.

FIG. 3 diagrammatically illustrates a triggering client-side probe according to an embodiment of the invention.

FIG. 4 diagrammatically illustrates collection of signal strength measurement at the APs according to an embodiment.

FIG. 5 diagrammatically illustrates estimation of the location of the client.

FIG. 6 is a block diagram of the control framework where the csm control application uses socket I/O to connect to qDock at the AP side and qDock uses another socket to talk to Wi-Fi drivers on the same AP.

FIG. 7 is a table showing the control interface according to the experimental set-up.

FIG. 8 is a diagram of an experimental set-up for testing localization.

FIG. 9 is a graph of RSSI values collected at the controller from the Galaxy S7 Edge measured at three different locations in the test set-up of FIG. 8.

FIG. 10 is plot of TCP performance showing real-time traffic throughput interrupted by 802.11v BTM triggered hand offs in the test set-up of FIG. 8.

FIGS. 11A and 11B compare the results of decoupling the scanning from roaming by toggling the A bit and the DI bit in two consecutive BTM requests in the test set-up of FIG. 8.

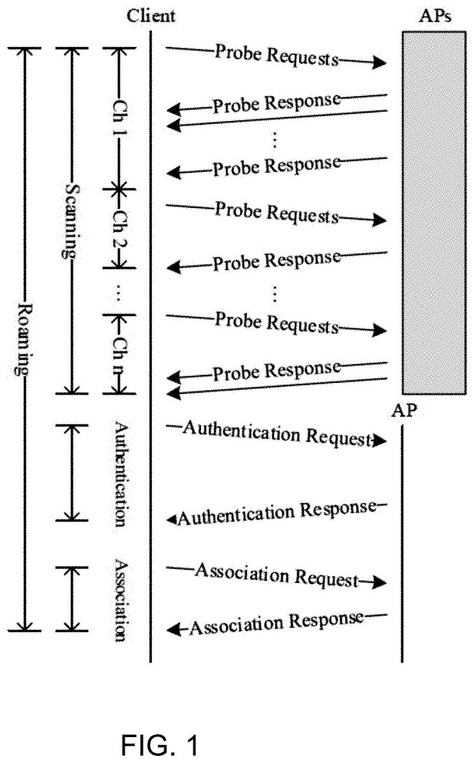

### DETAILED DESCRIPTION OF EMBODIMENTS

The disclosure provided herein describes exemplary embodiments of the invention and employs a number of industry-standard acronyms that are well known to those of skill in the field. Many of these acronyms are employed in the IEEE 802.11 standard, which is used in the sample implementation. For convenience, Table 1 provides a listing of acronyms used and their associated meanings.

TABLE 1

| Acronym | Meaning |
|---|---|
| A (bit) | Abridged bit |
| AP | Access Point |
| ARP | Address Resolution Protocol |
| BSSID | Basic Service Set Identifiers |
| BTM | BSSID Transition Management |
| DI (bit) | Disassociation Imminent bit |
| MAC | Media Access Control |
| MPTCP | Multi-path Transmission Control Protocol |
| PCT | Preferred Candidate List |
| RaaS | Roaming as a Service |
| RSSI | Received Signal Strength Indicator |

The IEEE 802.11 WLAN standards define how radio frequencies (RFs) are used for wireless links. Under the 802.11 standard, an access point (AP) periodically broadcasts beacons, attaching the information for nearby devices to connect. This beacon interval is commonly set to 100 ms, but the 802.11 standard leaves room for using different values. SyncScan (I. Ramani, et al., 2005) and ClientMarshal (A. Bhartia, et al., 2019) are two techniques that have exploited this degree of freedom. A clock and beacon synchronization across a large number of APs can be a challenge. To avoid such overhead, another feature of 802.11v protocol is exploited to allows the use of trigger selective scans at the client side without any hardware or firmware change.

The 802.11v protocol defines a set of new management frames. Among these frames, an unsolicited BSSID Transition Management (BTM) frame sent from an AP to a client may attach a preferred candidate list (PCL) along with their priority, BSSID, and operating channels. When a client receives a BTM frame, it extracts the information in the PCL and quickly starts an off-channel scan at its first availability. Because the client only needs to verify the existence of APs in the list, a selective scan rather than a full-channel scan is triggered.

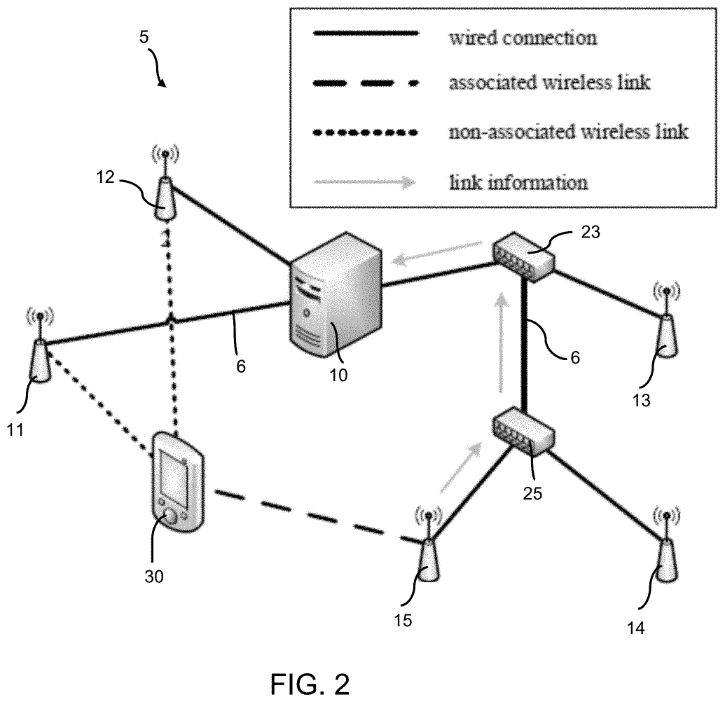

The embodiments disclosed herein employ a framework that allows BTM request sending and RSSI collecting. Referring to the diagram of an exemplary network architecture 5 shown in FIG. 2, all access points (APs) are connected to a logically centralized controller 10 via wired connection 6. In the illustrated example, five APs 11-15 are shown along with switches 23, 25 for communicating between client device 30 and controller 10. Client 30 is linked to the network via AP 15 and also detectable, via a non-associated wireless link, to AP 11 and AP 12. The illustrated architecture and data flows are examples of a typical enterprise wireless network in which all the APs are connected to a logically centralized control entity and under its control. Controller 10 is able to retrieve instantaneous link parameters, including throughput, signal strength, and identifiers for all connected clients 30. (Only one client is illustrated, however as will be readily apparent to those in the art, multiple clients may be connected to the same or different APs.) In other words, the controller knows which client is connected to a given AP as well as the corresponding throughput and signal strength.

The APs periodically send real-time station status with time stamps to the controller 10. A typical station status report includes media access control (MAC) layer address, received signal strength indicator (RSSI), channel number, sending and receiving rate, and angle of arrival/time of flight of incoming signal of the station.

For example, if a station can be seen by multiple APs operating on different channels, the controller 10 uses the status report from those APs to establish the location and the trajectory of the station. The controller 10 can also evaluate whether to keep the station associated with the current AP or to direct it to a different AP in order to maintain a desired quality of service.

To measure the environment, one can utilize active sensing in which a sender transmits reference pre-defined signal patterns over one frequency band (channel) and multiple receivers collect the incoming signal and evaluate the distortion on the same channel. If not all receivers are on the same channel, one of the parties must switch their channel. Orchestrating these changes can be challenging.

One existing solution could be to selectively put all the nodes on the same channels so that when one node sends traffic, all neighboring nodes can overhear the radio signals and measure link parameters. A significant shortcoming to this approach is that it limits the use of channel resources, making it impractical. A modified, more efficient approach would be to put nodes only on selective channels and trigger regular scans. When two nodes are on different channels, they cannot measure each other's link parameters easily. Because switching channels at the AP side would disrupt existing traffic, one can only ask a station to switch its channel and put APs only on selective channels to avoid the need for full channel scans. After a client switches to a new channel, it requires 100 milliseconds to capture beacons from APs and measure their signal strength. This process must be performed for each selective channel. For example, if there are 4 channels to scan, the client must spend (4−1)×100 ms=300 ms (excluding the currently associated AP) to complete a scan. This amount of time is long enough to disrupt VoIP traffic. In addition, allowing only four channels to be used is still a significant limitation. Further, at the end, the client must reply and provide its measurement back to the network infrastructure because it has no prior knowledge of APs location.

According to the inventive approach, to support the IEEE 802.11v standard and use BSSID transition management (BTM), the stations transmit a request frame to tell a client which AP on which channel to scan. Given that all the APs are under central control and their locations are known in advance, a client need only scan those APs that are close to its currently associated AP. In this case, instead of spending 100 ms in each channel, the client can perform an active scan by probing the targeted APs immediately (or nearly immediately) after it joins the channels because it already has the information for the targeted APs. An experiment shows that probing four APs on four different channels requires less than 100 ms, which is four times faster than passive scan scenarios.

The client's probing of the APs allows them to measure signal strength, time of flight, and/or angle of arrival parameters. These parameters can then be used to estimate the throughput and relative location of the client among all targeted APs.

In an approach described in U.S. Pat. No. 8,861,383 of Pandey et al., the disclosure of which is incorporated herein by reference, a wireless client receives a channel/AP list from its first associated AP. The client switches to different channels and passively waits for beacons from the non-associated APs. The client measures link parameters by using the beacons from the APs. The client switches back to the first channel and reports the measurement through the first associated AP to a controller. In contrast, in the inventive approach, a wireless client receives a channel/AP list from its first associated AP. The client switches to different channels and actively probes those non-associated APs. The APs measure link parameters by using the probe requests from the client. The wireless client switches back to the first channel and the controller retrieves link parameters from the APs.

This behavior has been confirmed in the source code of wpa_supplicant-2.6, a Wi-Fi manager that is widely found in many Linux and Android devices. The ieee802_11_rx_bss_trans_mgnt_req( ) function defined in wnm_sta.c serves as the basis for the inventive scheme. After a BTM request frame arrives at the client, its PCL is unpacked and roaming candidates are probed. wpa_supplicant will then direct the interface to probe these candidates, allowing measurement of RSSI at the AP side.

For a selective scan to work in an organized manner, each BTM request frame is customized based on time and location information. Further, to speed up the scanning process, only two or three neighboring APs are included in the PCL because scanning one channel can take 30-40 ms and spending too much time in scanning would negatively impact ongoing traffic.

The following are sample algorithms for performing the tasks of selecting roaming candidates and steering the client to the identified roaming candidate.

Algorithm 1: Find Roaming Candidate (Client)

| | |
|---|---|
| 1 | AP = GetAssociatedAP(Client); |
| 2 | RSSI = GetAssociatedRSSI(Client); |
| 3 | Candidate = AP; |
| 4 | Location = GetLocation(AP); |
| 5 | if RSS < rss_threshold then |
| 6 | Neighbors = SelectNeighbors(GetAllNeighbors(AP)); |
| 7 | BTM = BuildBTM(Neighbors, disassoc_imminent = |
| | False); |
| 8 | sendFrame(AP, BTM); |
| 9 | sleep(120 ms); /* wait for measurement */ |
| 10 | RssiMap = GetRssiMap( ) ∪ (AP, RSSI); |
| 11 | Location = EstimateLocation(RssiMap); |
| 12 | Candidate = SelectCandidate(Location); |
| 13 | end |
| 14 | return (Candidate, Location); |

Algorithm 2: Steer Client (Client, Candidate)

| | |
|---|---|
| 1 | AP = GetAssociatedAP(Client); |
| 2 | BTM = BuildBTM(Candidate, dissaoc_imminent = True); |
| 3 | sendFrame(AP, BTM); |
| 4 | sleep(100 ms); |
| 5 | if AP == GetAssociatedAP(Client) then |
| 6 | blacklistClient(AP, Client); |
| 7 | disassocClient(AP, Client); |
| 8 | sleep(3000 ms); |
| 9 | whitelistClient(AP, Client); |
| 10 | end |

Algorithm 1 returns the best roaming candidate for and the estimated location of the client. It consists of two key parts: selective scan and location estimation. An RSSI-based localization approach is used in the example with the assumption that channels are symmetric, meaning that if a client sees a strong RSSI value from an AP, that AP also can see a strong RSSI vale from the client. First, it is assumed that the currently associated AP is the candidate and its RSSI value is extracted. Second, a selective scan is triggered and an RSSI map is built. Finally, based on the RSSI map, determine whether to update the roaming candidate.

The inventive approach is not limited to a particular manner of localization because the key concept is the use of the 802.11v unsolicited BTM frame to trigger a selective scan. This causes the clients to proactively probe APs, thereby allowing retrieval of information necessary for localization or channel estimation. The choice of localization algorithm will affect the overall system complexity and result in different scalability. For example, an RSSI-based approach only requires one snapshot of the RSSI maps while a fingerprint-based approach requires RSSI fingerprints collected at many different locations. A channel state information-based approach would also require more training data and would therefore be less scalable.

Algorithm 2 handles roaming. If a client is “sticky”, meaning it refuses, or is reluctant, to roam to a new AP, the client will be disassociated and “blacklisted” for a short period, e.g., for three seconds, prior to returning the client to the white list and retrying.

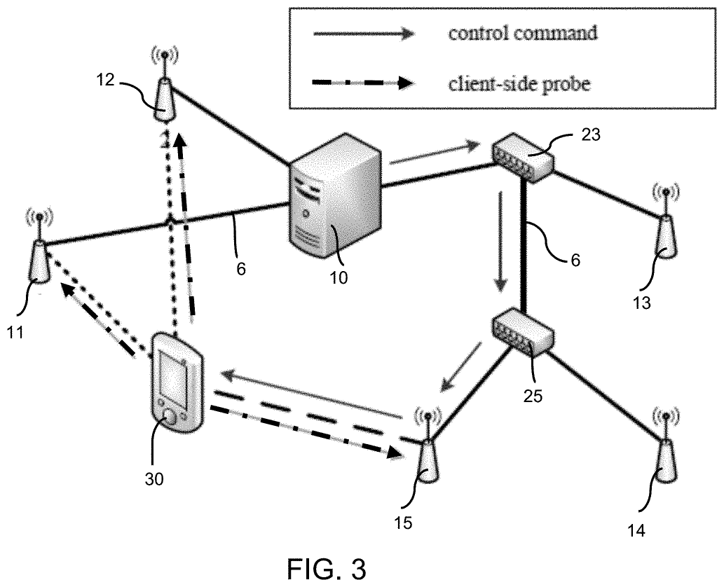

Using the same network architecture shown in FIG. 2, FIG. 3 illustrates the process of triggering the client-side probe. As shown, it is known that client 30 is connected with AP 15. Because the geographical locations of all the APs are already known, controller 10 can quickly include those within the vicinity of AP 15, e.g., AP 11, AP 12, AP 14, and AP 15 into the list of preferred candidates in an 802.11v BTM request frame and send it to the client, triggering the probe.

The inventive approach provides the freedom to decide which APs should be included on a list of potential or preferred candidates (i.e., the PCL). If more APs are included on the list, client 30 will be required to spend more time on a probe, so a balance can be established between speed and signal quality/continuity.

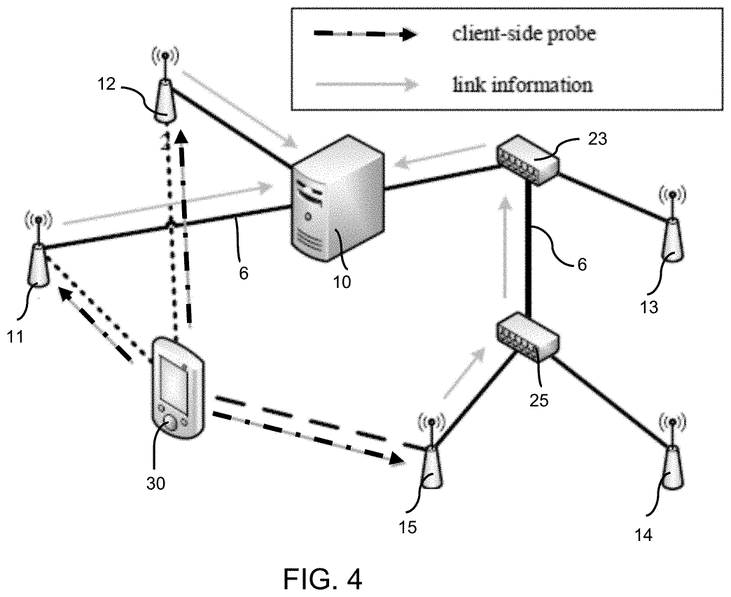

FIG. 4 illustrates collection of signal strength measurements at APs. After the client receives the BTM request frame, by default it must verify the existence of APs in the list by proactively probing these APs. Note that this procedure may vary somewhat in different devices. This mechanism can be found in many Linux-running clients including Google® Android® system and Apple® iOS system and provides the opportunity to measure signal strength at the APs that are being probed. Because wireless link information is regularly collected and recorded as a timestamped record, it is possible to determine if the client has finished probing, after which a snapshot can be built.

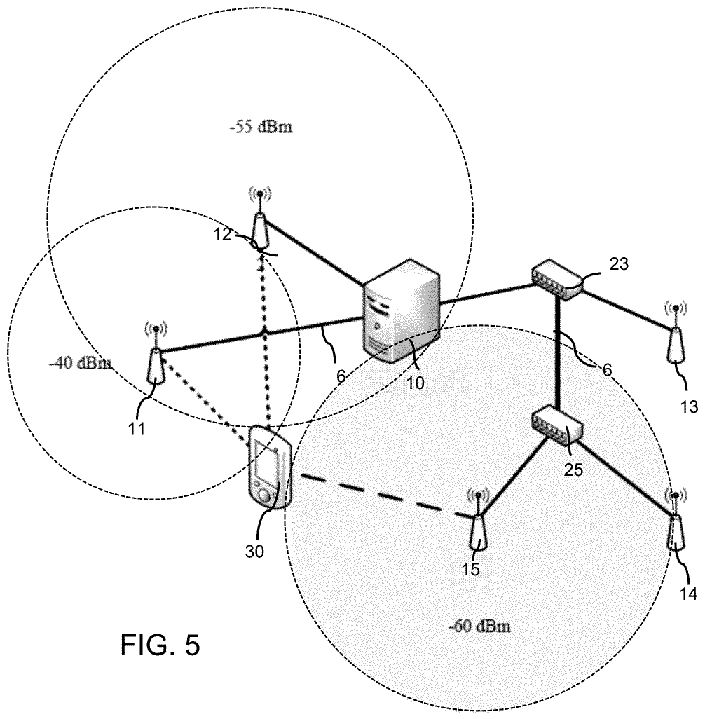

An example of estimating the location of the client is illustrated in FIG. 5. The probing process can usually be done in 100 ms, after which the most recently updated signal strength measurements can be collected from the APs.

TABLE 2

| | AP 11 | AP 12 | AP 13 | AP 14 | AP 15 | Time |
|---|---|---|---|---|---|---|
| Client | −40 | −55 | N/A | N/A | −60 | xx:xx:xx |
| | dBm | dBm | | | dBm | |

Table 2 provides an example of the signal strength for each of the APs that are probed. Note that there are no values provided for AP 13 and AP 14 because they may not have been included in the preferred candidate listing because their geographical locations were not within a specified vicinity. This approach uses the fact/assumption that the larger the distance between any two nodes, the weaker the signal strength will be to infer the relative location of the client among all APs. As shown in FIG. 5, each circle's diameter corresponds to the measured signal strength for the corresponding AP. Using the intersection between the three circles, the location of client 30 can be estimated.

### Example 1: Experimental Network Set-Up

The experimental framework for BTM request sending and RSSI collecting mirrors that shown in FIGS. 2-5. The controller 10 periodically asks APs 11-15 to send BTM requests to all clients 30 through their associated APs, which, in turn, triggers probe requests. Once a probe request arrives at an AP, the AP measures the RSSI, timestamps those samples, and stores them in a local database. The samples will be queried by the controller later. It is also logically reasonable that the gateway server shares the same machine as the location server and utilizes the existing connections between APs and the gateway machine.

To demonstrate the broad applicability of the inventive approach without the need for hardware or software modification at the client side, a testbed was chosen using two typical smartphones: Apple® iPhone® 7 (A1778) running iOS 12.4.1, and Samsung® Galaxy® S7 Edge (SM-G935T) running Android 8.0. Table 3 lists the specifications of the devices that were used in the experiments.

TABLE 3

| | AP | Client | |
|---|---|---|---|
| | Quantenna | Apple | Samsung |
| Device | QSR1000 | iPhone 7 | Galaxy S7 Edge |
| Wi-Fi module | Quantenna | Murata | Murata |
| | QT2518B | 339S00199 | KM5D18098 |
| Band | 5 GHz | 2.4/5 GHz | 2.4/5 GHz |
| Standard | a/n/ac | a/b/g/n/ac | a/b/g/n/ac |
| Antenna | 4 × 4 MIMO | 2 × 2 MIMO | 2 × 2 MIMO |
| configuration | | | |
| OS | Linux 2.6.35 | iOS 12.4.1 | Android 8.0 |
| Wi-Fi manager | hostapd | SBWiFiManager | WifiManager + |
| | | | wpa supplicant |
| 802.11v | supported | supported | supported |
| 802.11r | supported | supported | supported |

A Quantenna QSR1000 (ON Semiconductor, Phoenix, Ariz.) reference AP design was used for the infrastructure APs. This is one example of a possible platform for implementing the inventive system and method and is not intended to be limiting. As will be apparent to those in the art, such APs, or a similar design, can be found in many off-the-shelf devices as a 5 GHz Wi-Fi solution. This design runs Linux and is configured to produce real-time RSSI reports for each associated client device with packet-level granularity. A control panel was implemented for customized 802.11v BTM frame sending and RSSI collecting using Quantenna's SDK.

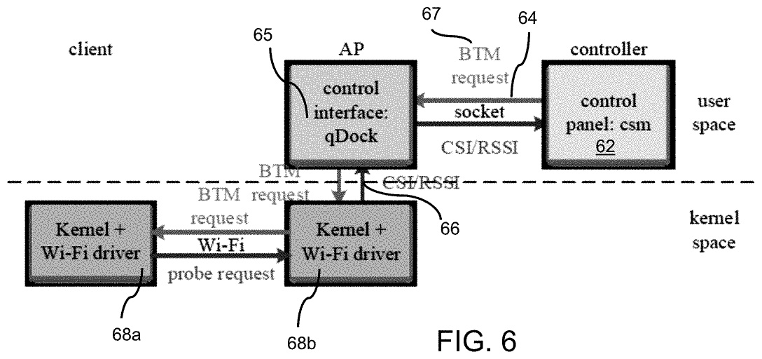

FIG. 6 illustrates the architecture and the data flows between the controller, the APs, and the clients in the test set-up. In this control framework, the csm control application 62 in the controller uses socket I/O 64 to connect to control interface qDock 65 at the AP side. qDock 65 uses another socket 66 to talk to Wi-Fi drivers 68a, 68b on the same AP. The controller compiles an unsolicited BTM frame 67 and sends it to the client through its associated APs. After the client receives the BTM request 67, it probes the APs listed in the PCL (preferred candidate list). The APs being probed then update the RSSI and the controller collects these samples to identify a roaming candidate.

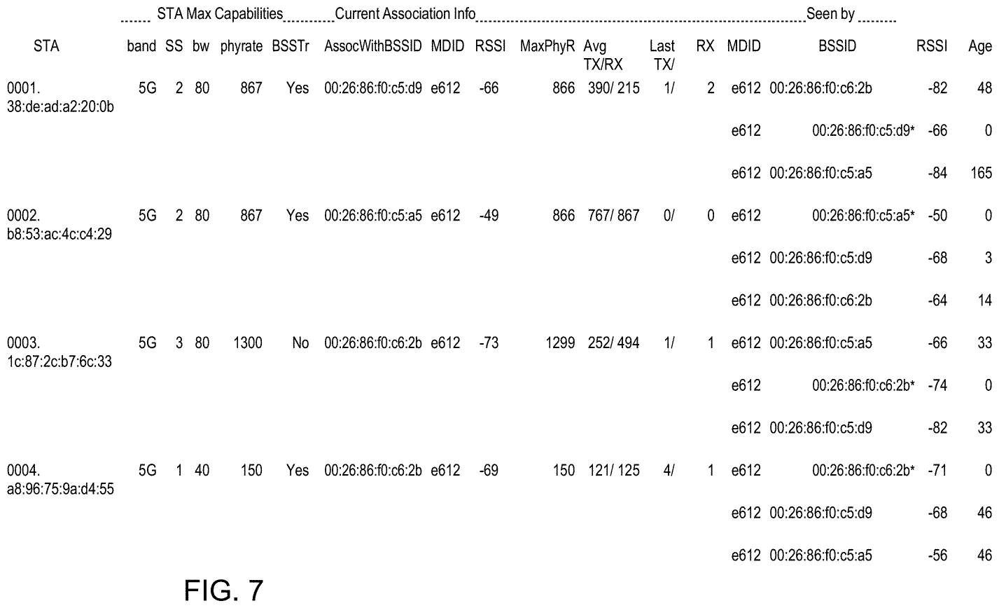

The table shown in FIG. 7 is a sample control interface 65 in the AP. The numbered MAC addresses on the left under the “STA” column are client stations, and the addresses under the “Seen By” column show the RSSI values measured by the APs. Age values (in the far righthand column) indicate the amount of time lapsed (in seconds) since the last RSSI update.

### Example 2: Impact of Frequent BTM Results

Initial testing involved determining how frequently updated RSSI samples could be obtained. This information was then used to construct a base to test how drivers react against unsolicited BTM requests at a fixed location. A BTM request contains three fields: 1) PCL (preferred candidate list), 2) abridged bit (A), and 3) disassociation imminent bit (DI), which can be customized. Abridged bit implies the strength of roaming suggestion and disassociation imminent bit informs whether the client will be disassociated if not moved. Note that even when DI was set, the client was not disassociated after the BTM request.

The following steps were performed:

1. Setup traffic with iPerf3 (a well-known management tool for IP networks).

2. Prepare a BTM request with a customized PCL, A, and DI fields. For example, (PCL=3*, A=1, DI=1) can be interpreted to mean there are three APs in the PCL; the AP strongly suggests that the client roam and disassociates from the client. The designation ‘*’ (an asterisk) is used to indicate that the currently associated AP is the most recommended one; otherwise, the AP suggests the client roam to a different AP.

3. Send the BTM request frame to the client.

4. Check the timestamps of RSSI measurement at the controller. If a timestamp of a particular AP is not refreshed, it implies that the client did not scan the AP. The results of this test are listed in Table 4.

TABLE 4

| BTM | | | Device Reactions | |
|---|---|---|---|---|
| AP | A | DI | iPhone 7 | Galaxy S7 Edge |
| 3 | 0 | 0 | scanned every 300 sec.; | scanned every 210 sec. |
| | | | not roamed | roamed |
| 3 | 1 | 0 | scanned every 300 sec.; | scanned every 210 sec. |
| | | | not roamed | roamed |
| 3 | 1 | 1 | scanned every 300 sec.; | scanned every 210 sec. |
| | | | roamed | roamed |
| 3* | 0/1 | 0/1 | no scan, no roam | no scan, no roam |
| 1 | 0 | 0 | scanned immediately; | scanned immediately; |
| | | | not roamed | roamed |
| 1 | 1 | 0 | scanned immediately; | scanned immediately; |
| | | | not roamed | roamed |
| 1 | 1 | 1 | scanned immediately; | scanned immediately; |
| | | | roamed | roamed |
| 1* | 0/1 | 0/1 | no scan, no roam | no scan, no roam |

Based on these test results, it was determined that as long as there were multiple APs in the PCL, both clients only scanned after 300 and 210 seconds, whereas when there was only one AP, both clients scanned that AP immediately after receiving the BTM request, triggering RSSI updates. It was also noted that the iPhone® was less inclined to roam, i.e., was “sticky”, while the Galaxy® S7 Edge always roamed in the tests.

### Example 3: Multi-Channel Localization

Some localization approaches disclosed in the prior art require multiple APs and the client to be on the same channel so that the traffic sent by the client can be overheard by multiple APs, allowing RSSI or CSI to be measured. This constraint is relaxed by using BTM-triggered selective scans.

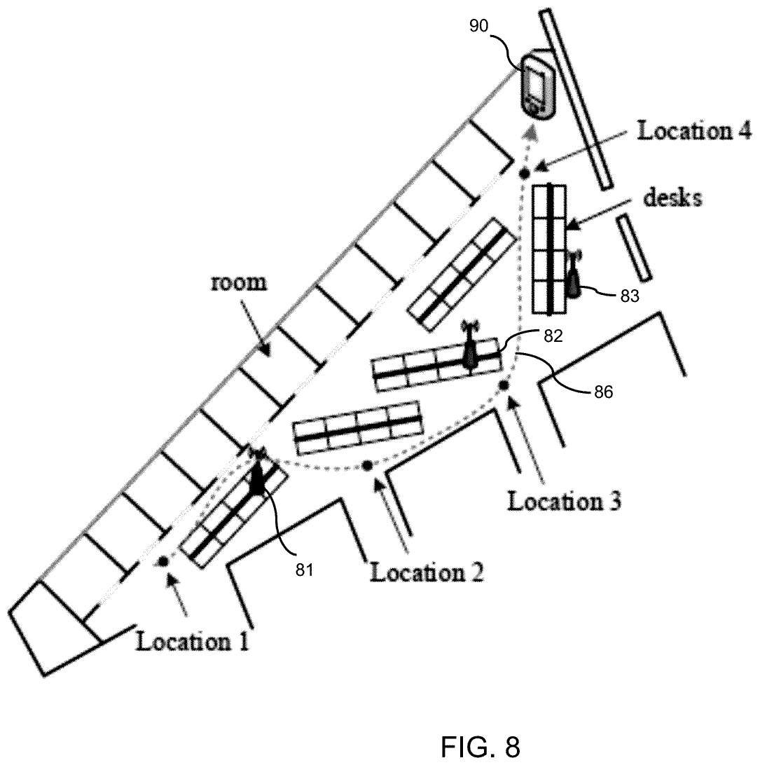

The indoor office environment utilized for testing consisted of multiple rooms and desks, the layout of which is shown in FIG. 8. A client smartphone 90 was connected to AP 81 on channel 36 at the beginning and traveled at walking speed along the dotted path 86, passing through another two Aps 82 and 83. Scans were triggered and RSSI values were measured at four different locations: Location 1, Location 2, Location 3, and Location 4.

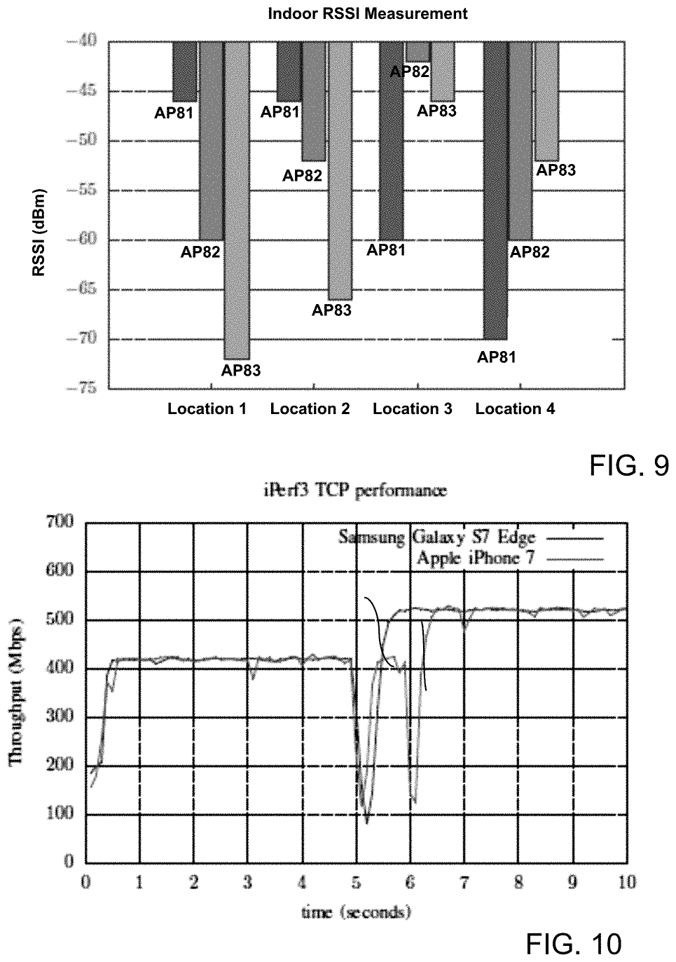

The visualized RSSI map seen by the controller is shown in FIG. 9. The controller could only detect a relative location of the smartphone among all three Aps. For example, RSSI values measured by AP 81 between Locations 1 and 2 were almost the same, but those measured by AP 82 and AP 83 were significantly different. The controller could thus infer that Location 2 is closer to AP 82 and AP 83 and came up with a hot zone in which the smartphone was most likely located. This was enough information for hand off decisions because a higher RSSI generally leads to better throughput in MAC layer, even though the overall throughput might be affected by other factors in upper layers.

### Example 4: Impact of Selective Scans

The prior examples demonstrated the ability to trigger selective scans. These results can also be used for localization and roaming. In this experiment, the goal was to determine the impact of the inventive approach on ongoing streaming traffic. More specifically, the goal was to determine if there would be a noticeable streaming delay, and, if so, how to mitigate such an impact. Using the same setup as described above, Wi-Fi frames were captured with the open source Wireshark® network protocol analyzer (Wireshark Foundation) installed on a PC. The real-time throughput was measured with a modified iPerf3 at 100 ms granularity.

The real-time TCP throughput measurement of two smart-phones are shown in FIG. 10. Before the traffic started, the phone was connected to a distant AP and a TCP flow was generated. Traffic started at t=0 second. At t=5 seconds, the controller sent out the first BTM request with one non-associated AP in the PCL, unset abridge bit, and unset disassociation imminent bit (AP=1, A=0, DI=0). The purpose of this BTM request was to force the phone to probe the target AP and update its information in the local database.

In these tests, the Galaxy® S7 Edge always roamed, taking 150 ms for traffic to recover. This was the expected behavior of wpa_supplicant and also suggested that Google® did not make many modifications, but simply included it in its Android® SDK. On the other hand, the iPhone® 7 did not roam in most of the tests and was generally less inclined to roam than the Galaxy® S7 Edge. These results indicated that its throughput dropped and recovered within 100 ms. To force the iPhone® 7 to connect to the targeted AP, we sent another BTM request with A=1 and DI=1 at t=6 seconds. The second throughput was also shorter than 100 ms, meeting the requirement.

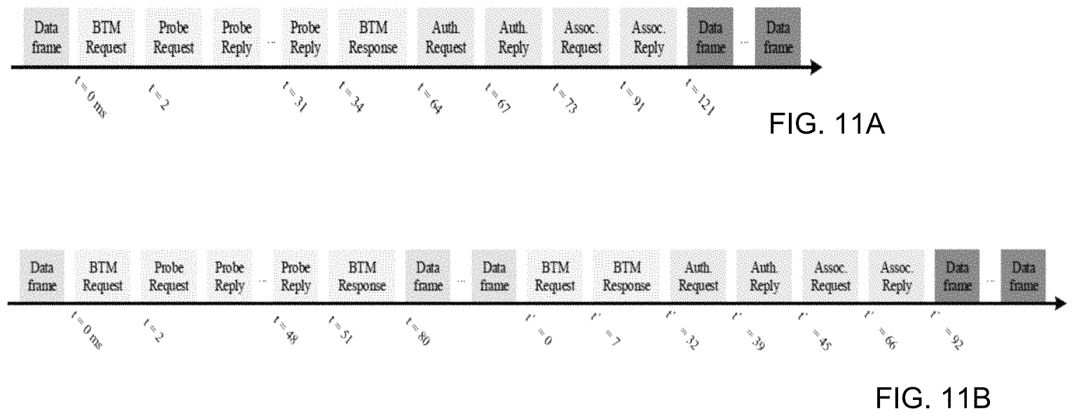

In FIG. 11A, when abridged bit (A) and disassociation imminent bit (DI) are set in an 802.11v BTM request frame, the client should hand off and connect to a new AP right after the scan, taking the overall process longer than 100 ms to complete. As shown in FIG. 11B, the decouple scan and hand off process can be implemented by clearing both the abridged bit (A) and the disassociation imminent bit (DI) so the client will not hand off after the scan, which makes the traffic gap shorter than 100 ms. If a hand off is necessary, the controller sends another BTM request with only the targeted AP and sets both the A bit and the DI bit. In cases where client roaming is not desired, but rather the client's location is desired, only the first BTM request need be sent out.

The above test results demonstrated that different clients react differently to the same set of BTM requests. For example, the Galaxy® S7 Edge behaved more compliantly than did iPhone® 7. A similar observation has been acknowledged in a Cisco Tech Report, which pointed out that Apple® built its own Wi-Fi scoring system, and iOS devices will only roam when the RSSI of the suggested AP is at least 8 dBm better than its currently associated AP. This presents an obstacle to freely steering iOS devices, even when there is a load balancing demand.

As a result, in order to force an iOS device to connect to a desired AP, it is necessary to send back-to-back BTM requests to force a hand off. However, it may not be appropriate to steer that iOS device if it is known that the targeted AP is not 8 dBm greater in signal strength than the device's currently associated AP. Android® devices rely on open sourced wpa_supplicant, however, they are more likely to roam even when a selective scan is to be performed. The source code of wpa_supplicant-2.9 (v2.6 and v2.9) was reviewed and confirmed that 1) abridged bit (A) is not involved in any part of its roaming decision; 2) disassociation imminent bit (DI) will force it to schedule a scan and it is up to the driver's decision as to whether to perform a scan; and 3) when there is only one AP in PCL (AP=1), the scheduled scan will also include the targeted BSSID. This matches the results discussed above in Example 2.

Switching connections inevitably causes traffic stop and the goal is to find an efficient and systematic way to minimize the impact of traffic stop before the buffer is depleted in order to boost the overall user experience.

The system and method disclosed herein are directed to the implementation of Wi-Fi roaming as a location-based service, and to turn the conventional, client-initiated roaming process into an infrastructure-aided roaming procedure. Unlike some existing approaches that either require hardware modification at the client side or sophisticated infrastructure design, the inventive approach relies on the 802.11v standard, which is widely supported in many smartphones. The test results confirm that even though the reactions of clients may differ from one to another, there exists a set of parameters in the BTM request frame that can always trigger a scan on typical smartphones. Additionally, at the infrastructure side, a location server package can be installed at a gateway machine that allows client location to be estimated through 802.11v BTM-triggered selective scans. In general, a throughput gain was observed when the smartphones were connected to an AP with a better RSSI.

### REFERENCES (INCORPORATED HEREIN BY REFERENCE)

[1] Y. Chen, et al., “QoS Requirements of Network Applications on the Internet,” Inf. Knowl. Syst. Manag., vol. 4, no. 1, pp. 55-76, January 2004.
[2] C-C. Tseng, et al., “Location-based fast handoff for 802.11 networks,” IEEE Communications Letters, vol. 9, no. 4, pp. 304-306, April 2005.
[3] I. Ramani and S. Savage, “SyncScan: practical fast handoff for 802.11 infrastructure networks,” in Proceedings IEEE 24^{th} Annual Joint Conf. of the IEEE Computer and Communications Societies., vol. 1, March 2005, pp. 675-684 vol. 1.
[4] V. Brik, et al., “Eliminating Handoff Latencies in 802.11 WLANs Using Multiple Radios: Applications, Experience, and Evaluation,” in Proceedings of the 5^{th} ACM SIGCOMM Conference on Internet Measurement, ser. IMC '05. Berkeley, Calif., USA: USENIX Association, 2005, pp. 27-27.
[5] C. Paasch, et al., “Exploring mobile/wifi handover with multipath tcp,” in Proceedings of the 2012 ACM SIGCOMM Workshop on Cellular Networks: Operations, Challenges, and Future Design, ser. CellNet '12. New York, N.Y., USA: ACM, 2012, pp. 31-36.
[6] Y. Lim, et al., “Cross-layer path management in multi-path transport protocol for mobile devices,” in IEEE INFOCOM 2014—IEEE Conference on Computer Communications, April 2014, pp. 1815-1823.
[7] A. Ford, et al., “TCP Extensions for Multipath Operation with Multiple Addresses,” Internet Requests for Comments, RFC Editor, RFC 6824, January 2013.
[8] P. Brida, et al., “On the accuracy of weighted proximity based localization in wireless sensor networks,” in Personal Wireless Communications, R. Bestak, et al., Eds. Boston, Mass.: Springer US, 2007, pp. 423-432.
[9] S. Jin, et al., “Fast scanning schemes for IEEE 802.11 wlans in virtual ap environments,” Computer Networks, vol. 55, no. 10, pp. 2520-2533, 2011.
[10] A. Bhartia, et al., “Clientmarshal: Regaining control from wireless clients for better experience,” in The 25^{th} Annual International Conference on Mobile Computing and Networking, ser. MobiCom '19. New York, N.Y., USA: ACM, 2019, pp. 6:1-6:16.
[11] J. Malinen, “Linux WPA/WPA2/IEEE 802.1X Supplicant.”
[12] J. Dugan, et al., “iPerf—The ultimate speed test tool for TCP, UDP and SCTP.”
[13] H. Lim, et al., “Zero-configuration, robust indoor localization: Theory and experimentation,” in Proceedings IEEE INFOCOM 2006. 25^{TH} IEEE International Conference on Computer Communications, April 2006, pp. 1-12.
[14] M. Kotaru, et al., “SpotFi: Decimeter Level Localization Using WiFi,” in Proceedings of the 2015 ACM Conference on Special Interest Group on Data Communication, ser. SIGCOMM '15. New York, N.Y., USA: ACM, 2015, pp. 269-282.
[15] Cisco Systems, Inc., “iPhone 6 Roaming Behavior and Optimization.”

1. A method for managing connection of a wireless client to a wireless network comprising a plurality of access points (APs), the method comprising:
configuring a network controller to collect location information from the wireless client using a standardized hand-off protocol by:
receiving at the wireless client a channel/AP list from a first associated AP;
switching the wireless client to a different channel and actively probing one or more non-associated APs;
measuring link parameters at the one or more non-associated APs by using the probe requests from the wireless client;
switching the wireless client back to the first associated AP;
retrieving link parameters from the one or more non-associated APs; and
providing information to the wireless client for linking to a different AP based on the link parameters.

2. The method of claim 1, wherein the network controller identifies a preferred subset of APs based on the link parameters and generates a preferred candidate list (PCL) comprising non-associated APs and wherein the information provided to the wireless client includes the PCL.

3. The method of claim 1, wherein the wireless network operates on an industry standard that comprises BSSID Transition Management (BTM) frames, and wherein the step of receiving at the wireless client is initiated by transmitting from the first associated AP an unsolicited BTM frame to trigger a selective scan of the one or more non-associated APs.

4. The method of claim 3, wherein the industry standard is IEEE 802.11v.

5. The method of claim 1, wherein the link parameters retrieved from at least three APs include signal strength, and wherein a location of the wireless client is estimated from a combination of the signal strengths retrieved at the at least three APs.

6. The method of claim 5, wherein the estimated location of the wireless client comprises an intersection of symmetrical areas having diameters corresponding to the signal strengths.

7. A method for managing connection of a wireless client to a wireless network comprising a controller and a plurality of access points (APs), wherein the wireless network operates on an industry standard protocol that comprises BSSID Transition Management (BTM) frames, the method comprising:
transmitting from a first associated AP in communication with the wireless client an unsolicited BTM frame comprising a preferred list of non-associated APs, wherein the BTM frame triggers a selective scan by the wireless client of the preferred non-associated candidate APs;
returning from the wireless client to the controller link parameters for each of the preferred non-associated candidate APs; and
if the link parameters for one of the preferred non-associated APs indicate an improved connection relative to the first associated AP, switching the wireless client to the preferred non-associated AP.

8. The method of claim 7, wherein the industry standard is IEEE 802.11v.

9. The method of claim 7, wherein the link parameters retrieved from at least three APs include signal strength, and wherein a location of the wireless client is estimated from a combination of the signal strengths retrieved at the at least three APs.

10. The method of claim 9, wherein the estimated location of the wireless client comprises an intersection of symmetrical areas having diameters corresponding to the signal strengths.

11. A method for managing connection of a wireless client to a wireless network comprising a plurality of access points (APs) and a network controller, the method comprising:
receiving at the wireless client a channel/AP list from a first associated AP of the plurality of APs;
switching the wireless client to a different channel and causing the wireless client to actively probe one or more non-associated APs on the channel/AP list;
measuring link parameters at the one or more non-associated APs by using the probe requests from the wireless client;
switching the wireless client back to the first associated AP;
retrieving link parameters from the one or more non-associated APs; and
providing information to the wireless client for linking to a different AP based on the link parameters.

12. The method of claim 11, wherein the network controller identifies a preferred subset of APs based on the link parameters and generates a preferred candidate list (PCL) comprising non-associated APs and wherein the information provided to the wireless client includes the PCL.

13. The method of claim 11, wherein the wireless network operates on an industry standard that comprises BSSID Transition Management (BTM) frames, and wherein the step of receiving at the wireless client is initiated by transmitting from the first associated AP an unsolicited BTM frame to trigger a selective scan of the one or more non-associated APs.

14. The method of claim 13, wherein the industry standard is IEEE 802.11v.

15. The method of claim 1, wherein the link parameters retrieved from at least three APs include signal strength, and wherein a location of the wireless client is estimated from a combination of the signal strengths retrieved at the at least three APs.

16. The method of claim 15, wherein the estimated location of the wireless client comprises an intersection of symmetrical areas having diameters corresponding to the signal strengths.
